(19) United States
(12) Patent Application Publication
(10) Pub. No.: US 2022/0106001 A1
(43) Pub. Date: Apr. 7, 2022

(54) TRAVELING ROBOT, TRAVELING ROBOT CONTROL METHOD, AND PROGRAM

(71) Applicant: SONY GROUP CORPORATION, TOKYO (JP)

(72) Inventors: NORIAKI TAKASUGI, TOKYO (JP); WATARU KOKUBO, TOKYO (JP); MASAYA KINOSHITA, TOKYO (JP); YASUNORI KAWANAMI, TOKYO (JP)

(21) Appl. No.: 17/428,038

(22) PCT Filed: Dec. 24, 2019
(86) PCT No.: PCT/JP2019/050492

§ 371 Date: Aug. 3, 2021

(30) Foreign Application Priority Data
Feb. 13, 2019 (JP) 2019-023211

(51) Int. Cl. B62D 57/028; G05D 1/02; B62D 57/032; B60K 31/00

(52) U.S. Cl. CPC B62D 57/028; B60K 31/00; B62D 57/032; G05D 1/021

(57) ABSTRACT

There is achieved a traveling robot configured to travel by switching between leg driving and wheel driving while suppressing a decrease in velocity in switching between the leg driving and the wheel driving. The traveling robot includes a drive unit, a clutch configured to switch a transmission destination of a driving force from the drive unit, a leg and a wheel that are configured to be driven by the driving force from the drive unit, and a control unit. The control unit executes, in drive switching between leg driving and wheel driving, travel velocity control before the drive switching such that a travel velocity after the drive switching is substantially equal to a travel velocity before the drive switching. The control unit sets, in the drive switching between the leg driving and the wheel driving, a sliding movement state in which the wheel is caused to slide in a non-driven state. The control unit executes, in the drive switching, acceleration processing before the drive switching such that a travel velocity after the drive switching is substantially equal to a travel velocity before the drive switching.

### TECHNICAL FIELD

The present disclosure relates to a traveling robot, a traveling robot control method, and a program. Specifically, the present disclosure relates to a traveling robot configured to move by switching between leg traveling by which the traveling robot walks by moving its legs back and forth and wheel traveling by which the traveling robot moves by rotating its wheels, a traveling robot control method, and a program.

### BACKGROUND ART

There has been a traveling robot configured to move by switching between leg traveling by which the traveling robot walks by moving its legs back and forth and wheel traveling by which the traveling robot moves by rotating its wheels. However, such a traveling robot is required to accommodate and fix the legs in places above the grounding surfaces of the wheels in the wheel traveling. Further, the traveling robot is required to control the grounding surfaces of the legs to positions below the wheels in the leg traveling.

Further, to reduce the weight of the traveling robot configured to move by switching between the leg traveling and the wheel traveling, the traveling robot preferably drives the legs and the wheels by a single driving source for the legs and the wheels, namely, an actuator such as a motor, instead of a plurality of driving sources. However, the configuration in which the actuator is shared has a problem in that a time lag occurs in switching between the legs and the wheels, so that the movement velocity decreases in this switching period.

As a related art that discloses a traveling robot configured to move by switching between leg traveling and wheel traveling, for example, PTL 1 (Japanese Patent Laid-open No. 2009-113135) is given. PTL 1 discloses a biped robot having, at the distal end of its leg, a three-point contact foot including a wheel and a support. This configuration has an advantage that the legs and the wheels can be switched in a short time. However, drive wheel actuators are required and the weight cost is thus large, which is a problem. Further, since leg actuators are used to support the self-weight even in the wheel movement mode, the energy efficiency in movement is poor, which is a disadvantage.

Further, PTL 2 (Japanese Patent Laid-open No. 2008-260117) discloses a robot including wheels in hip joint portions and configured to control power supply with a power source common to hip joint actuators and drive wheel actuators, to thereby switch between the legs and the wheels. While the robot is moving with the wheels, the legs are kept at predetermined positions.

This configuration uses the same power source for the legs and the wheels but consumes a large amount of energy since the actuators are required to be driven for self-weight compensation of the legs in the wheel traveling. Further, the drive wheel actuators are additionally required.

Further, PTL 3 (Japanese Patent Laid-open No. 2008-062306) discloses a leg robot having knee joints on the circle frames of the wheels and configured to achieve wheel movement with the circle frames by controlling the legs to be positioned in the circle frames.

This configuration achieves seamless movement with the legs and the wheels. However, the legs cannot be longer than the radius of the circle frames of the wheels, which means that the length of the legs cannot be designed freely. Further, to control the positions of the legs in the wheel traveling, leg actuators require power supply even in the wheel traveling.

Moreover, PTL 4 (Japanese Patent Laid-open No. 2008-049429) discloses a robot configured to drive its legs and wheels by the same number of motors. The robot moves with the wheels by driving the motors in a synchronous manner and walks with the legs by driving the motors in a differential manner to swing the legs.

This configuration efficiently utilizes the motors in both the wheel movement and the leg movement but requires as many wheels as the joints of the legs and is thus heavy, which is a disadvantage. Further, the leg movement mode and the wheel movement mode cannot be seamlessly switched.

As described above, the plurality of related arts discloses the traveling robots configured to move by switching between the leg traveling and the wheel traveling, but none of the related arts discloses a configuration for eliminating a decrease in movement velocity in switching between the leg driving and the wheel driving.

### CITATION LIST

### Patent Literature

### [PTL 1]

Japanese Patent Laid-open No. 2009-113135

### [PTL 2]

Japanese Patent Laid-open No. 2008-260117

### [PTL 3]

Japanese Patent Laid-open No. 2008-062306

### [PTL 4]

Japanese Patent Laid-open No. 2008-049429

### SUMMARY

### Technical Problem

The present disclosure has been made in view of the above-mentioned problems, for example, and has an object to provide a traveling robot configured to continuously travel by switching between leg traveling and wheel traveling while suppressing a decrease in movement velocity in switching between the legs and the wheels, a traveling robot control method, and a program.

### Solution to Problem

According to a first aspect of the present disclosure, there is provided a traveling robot including a drive unit, a clutch configured to switch a transmission destination of a driving force from the drive unit, a leg configured to be driven by the driving force from the drive unit, a wheel configured to be driven by the driving force from the drive unit, and a control unit. The control unit executes, in drive switching between leg driving and wheel driving, travel velocity control before the drive switching such that a travel velocity after the drive switching is substantially equal to a travel velocity before the drive switching.

Moreover, according to a second aspect of the present disclosure, there is provided a traveling robot control method executed by a traveling robot, the traveling robot including a drive unit, a clutch configured to switch a transmission destination of a driving force from the drive unit, a leg and a wheel that are configured to be driven by the driving force from the drive unit, and a control unit. The control unit executes, in drive switching between leg driving and wheel driving, travel velocity control before the drive switching such that a travel velocity after the drive switching is substantially equal to a travel velocity before the drive switching.

Moreover, according to a third aspect of the present disclosure, there is provided a program for causing a traveling robot to execute traveling robot control, the traveling robot including a drive unit, a clutch configured to switch a transmission destination of a driving force from the drive unit, a leg and a wheel that are configured to be driven by the driving force from the drive unit, and a control unit. The program causes the control unit to execute, in drive switching between leg driving and wheel driving, travel velocity control before the drive switching such that a travel velocity after the drive switching is substantially equal to a travel velocity before the drive switching.

Note that the program of the present disclosure is a program that can be provided with a recording medium or a communication medium configured to provide the program in a computer-readable format to an information processing device or a computer system capable of executing various program codes, for example. By providing such a program in a computer-readable format, processing in accordance with the program is achieved on the information processing device or the computer system.

Other purposes, features, and advantages of the present disclosure will become apparent by detailed description based on embodiments of the present disclosure and the appended drawings, which are described later. Note that the term “system” herein includes a configuration in which a plurality of devices is logically grouped and is not limited to a configuration in which the devices are disposed within the same housing.

According to a configuration of an embodiment of the present disclosure, the traveling robot configured to travel by switching between the leg driving and the wheel driving while suppressing a large change in velocity such as a decrease in velocity in switching between the leg driving and the wheel driving is achieved.

Note that the effects described herein are just examples and are not limitative, and there may be additional effects.

### BRIEF DESCRIPTION OF DRAWINGS

FIG. 1 is a diagram illustrating a configuration example of a traveling robot of the present disclosure.

FIG. 2 is a diagram illustrating a traveling example of the traveling robot of the present disclosure.

FIG. 3 is a diagram illustrating control examples of driving force transmission and a lock mechanism when the traveling robot of the present disclosure is traveling.

FIG. 4 is a diagram illustrating exemplary travel control processing that is executed by the traveling robot of the present disclosure.

FIG. 5 is a diagram illustrating exemplary travel control processing that is executed by the traveling robot of the present disclosure.

FIG. 6 is a flowchart illustrating a sequence of processing that is executed by the traveling robot of the present disclosure.

FIG. 7 is a diagram illustrating state transition of the traveling robot of the present disclosure when the traveling robot is traveling.

FIG. 8 is a diagram illustrating state transition of the traveling robot of the present disclosure when the traveling robot is traveling.

FIG. 9 is a flowchart illustrating a sequence of processing that is executed by the traveling robot of the present disclosure.

FIG. 10 is a diagram illustrating state transition of the traveling robot of the present disclosure when the traveling robot is traveling.

FIG. 11 is a diagram illustrating state transition of the traveling robot of the present disclosure when the traveling robot is traveling.

FIG. 12 is a diagram illustrating a configuration example of the traveling robot of the present disclosure.

FIG. 13 is a diagram illustrating a configuration example of the traveling robot of the present disclosure.

FIG. 14 is a diagram illustrating a traveling example of the traveling robot of the present disclosure.

FIG. 15 is a diagram illustrating a traveling example of the traveling robot of the present disclosure.

FIG. 16 is a diagram illustrating a traveling example of the traveling robot of the present disclosure.

FIG. 17 is a diagram illustrating a traveling example of the traveling robot of the present disclosure.

FIG. 18 is a diagram illustrating a hardware configuration example of the traveling robot of the present disclosure.

### DESCRIPTION OF EMBODIMENTS

Now, details of a traveling robot, a traveling robot control method, and a program of the present disclosure are described with reference to the drawings. Note that the following items are described in order.

1. Outline of Traveling robot of Present Disclosure

2. Details of Switching Sequence from Leg Driving to Wheel Driving

3. Details of Switching Sequence from Wheel Driving to Leg Driving

4. Other Embodiments

5. Hardware Configuration Example of Traveling robot

6. Conclusion of Configuration of Present Disclosure

### 1. Outline of Traveling robot of Present Disclosure

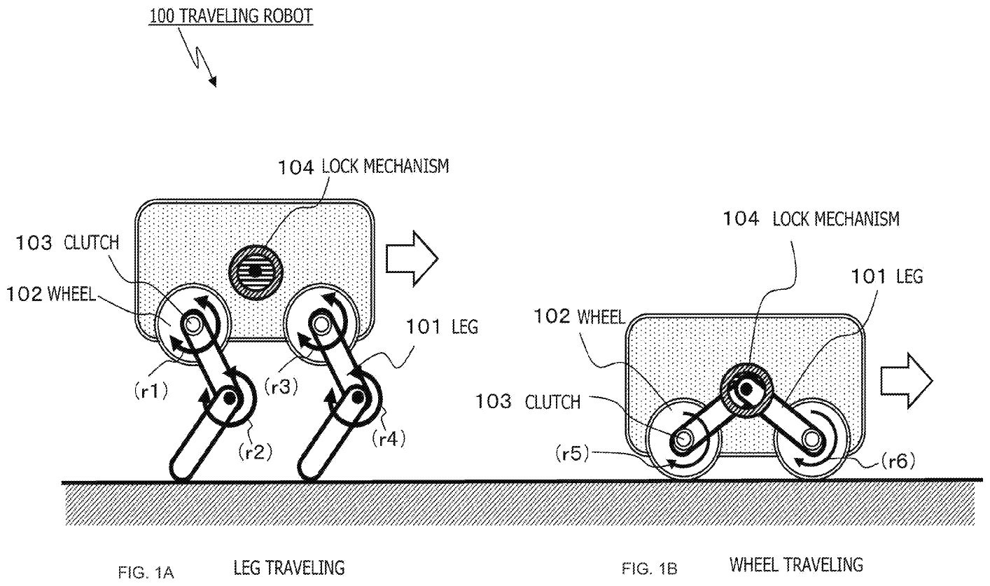

First, an outline of a traveling robot of the present disclosure is described with reference to FIG. 1 and the following figures.

FIG. 1 is a diagram illustrating a traveling robot 100 of the present disclosure.

The traveling robot 100 of the present disclosure is a traveling robot configured to move by switching between leg traveling by which the traveling robot walks by moving its legs back and forth and wheel traveling by which the traveling robot moves by rotating its wheels.

The traveling robot illustrated in FIG. 1 has a configuration that uses, as a drive unit, a common actuator such as a motor. With the configuration in which the single drive unit is shared in this way, a reduction in total weight is achieved.

As illustrated in FIG. 1, the traveling robot 100 can perform (a) leg traveling and (b) wheel traveling. In the example illustrated in the figure, the traveling robot 100 is traveling in a direction of arrows (from the left to the right).

Note that the two traveling examples of (a) the leg traveling and (b) the wheel traveling are illustrated in the figure, and the traveling robot 100 can switch between (a) the leg traveling and (b) the wheel traveling during traveling. In this switching during traveling, the switching between (a) the leg traveling and (b) the wheel traveling is achieved without a decrease in velocity or a large change in velocity.

As illustrated in FIG. 1, the traveling robot 100 includes legs 101, wheels 102, clutches 103, and a lock mechanism 104.

The legs 101 are used in the leg traveling, which is a walking mode. Joint portions are rotationally driven by a driving force from the actuator such as a motor. That is, the driving force from the actuator such as a motor is converted into joint portion rotational driving motions r1, r2, r3, and r4 illustrated in the figure to move the legs 101 back and forth. The leg traveling, which is a walking mode, is achieved in this way.

The wheels 102 are used in the wheel traveling. The wheels 102 are rotationally driven by a driving force from the actuator such as a motor. That is, the driving force from the actuator such as a motor is converted into axle portion rotational driving motions r5 and r6 illustrated in the figure to rotate the wheels 102. The wheel traveling is achieved in this way.

A configuration of the clutches 103 is not described in detail. The clutch 103 includes a driving force transmission destination switching mechanism configured to switch between a leg drive setting in which the driving force from the actuator such as a motor is transmitted to the legs 101 and a wheel drive setting in which the driving force is transmitted to the wheels 102.

For example, the clutch 103 includes a dog clutch configured to switch the transmission destination of power from the actuator such as a motor.

In the walking movement using the legs 101, power from the actuator is transmitted to the joint portions of the legs 101 through the clutches 103, so that the legs are driven. In this leg drive period, no driving force is transmitted to the wheels 102. Further, in the wheel traveling using the wheels 102, power from the actuator is transmitted to the wheels through the clutches 103. In this period, no driving force is transmitted to the legs. Note that the mechanism configured to switch the transmission destination of power from the actuator is not limited to the dog clutch and may be an electromagnetic clutch or the like.

The lock mechanism 104 is a mechanism configured to fix the legs 101 in the wheel traveling illustrated in FIG. 1(b). As the lock mechanism 104, for example, a mechanism configured to insert a pin provided to the lock mechanism 104 into a hole or a depression formed in the leg 101, thereby fixing the leg 101 to the robot body can be used.

With the processing of fixing the legs 101 by the lock mechanism 104, in the wheel traveling illustrated in FIG. 1(b) where no power is transmitted to the legs 101, the legs 101 can be prevented from coming into contact with or interfering with the wheels 102 or the ground.

Note that a driving force from the driving source for the legs 101 and the wheels 102 can be utilized for the lock processing and unlock processing by the lock mechanism 104.

Note that the lock mechanism 104 in the configuration illustrated in FIG. 1 is the single lock mechanism 104 shared by the legs 101, which are a foreleg and a hind leg, but the lock mechanism 104 may be provided to each leg.

Note that, in the figure, only the two legs 101 and only the two wheels 102 are illustrated, but there are legs and wheels on the back side of the figure. The configuration includes the four legs 101 and the four wheels 102.

The lock mechanism 104 may be a single lock mechanism configured to fix all the four legs. Further, the lock mechanism 104 may be a lock mechanism sharing its structure with the clutch mechanisms 103 described above.

Note that the traveling robot 100 illustrated in FIG. 1 includes a sensor configured to measure rotation angles of the legs 101 and the wheels 102, an encoder, and a speedometer. Further, the traveling robot 100 includes a sensor configured to detect a travel environment. The sensor determines conditions of travel surfaces, for example, determines whether a surface is smooth leveled ground or unsmooth uneven ground. For example, the wheel traveling is performed on leveled ground, and the leg traveling is performed on uneven ground.

Moreover, the sensor detects whether a travel surface is a flat surface, an uphill, or a downhill, and a slope angle, or whether the travel surface is a stepped uphill or a stepped downhill, and a step size. The sensor includes a camera and a distance sensor, for example.

A control unit of the traveling robot executes travel control on the basis of information detected by these sensors and speedometer. Specifically, the control unit performs switch control between the leg traveling using the legs 101 and the wheel traveling using the wheels 102. Moreover, the control unit controls travel velocities in the leg traveling using the legs 101 and the wheel traveling using the wheels 102.

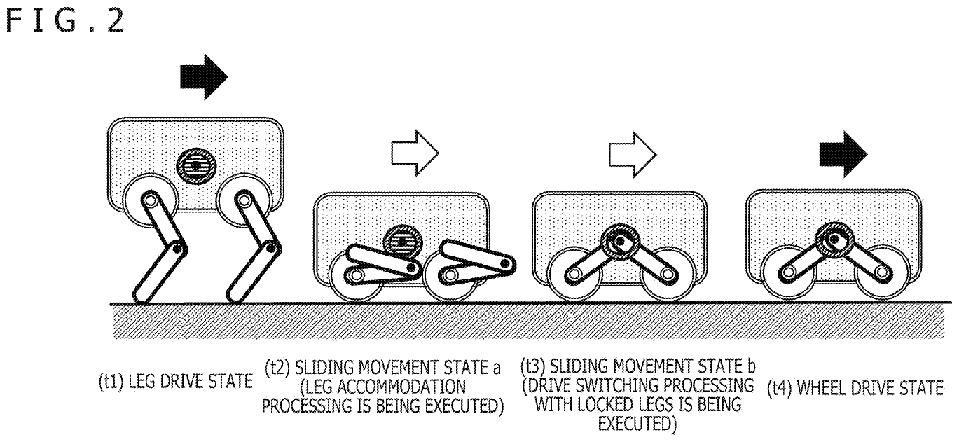

Next, with reference to FIG. 2, the processing of switching between the leg traveling and the wheel traveling that is executed by the traveling robot 100 is described.

As described above, the control unit of the traveling robot 100 performs the wheel traveling on leveled ground and the leg traveling on uneven ground, for example.

FIG. 2 illustrates a transition example from the leg drive state to the wheel drive state. As illustrated in FIG. 2, in a case where the traveling robot transitions from the leg drive state to the wheel drive state, the state of the traveling robot changes as follows over time.

(t1) Leg drive state

(t2) Sliding movement state a (leg accommodation processing is being executed)

(t3) Sliding movement state b (drive switch processing with locked legs is being executed)

(t4) Wheel drive state

(t1) The leg drive state is a state in which a driving force from the actuator such as a motor is being transmitted to the legs 101, so that traveling by the leg driving is being executed.

(t2) The sliding movement state a (leg accommodation processing is being executed) is a period in which processing of accommodating the legs 101 is executed. In this period, the driving force from the actuator such as a motor is being transmitted to the legs 101, but this driving force is used for the processing of accommodating the legs 101, that is, for moving the legs 101 to a lock position of the lock mechanism 104.

Thus, in this period, the driving force from the actuator such as a motor cannot be used for the processing of moving the traveling robot 100. In this period, sliding movement with the spinning wheels 102 supplied with no driving force is performed.

(t3) The sliding movement state b (drive switch processing with locked legs is being executed) is a period in which processing of switching the destination of the driving force from the actuator such as a motor from the legs 101 to the wheels 102 is executed after the legs 101 have been locked to the lock mechanism 104.

That is, with switching control by the clutches 103, the destination of the driving force from the actuator such as a motor is switched from the legs 101 to the wheels 102.

Also in this period, the driving force from the actuator such as a motor cannot be used for the processing of moving the traveling robot 100. Also in this period, sliding movement with the spinning wheels 102 supplied with no driving force is performed.

(t4) The wheel drive state is a state in which the destination of the driving force from the actuator such as a motor has been switched to the wheels 102. With control by the clutches 103, the driving force from the actuator such as a motor is transmitted to the wheels 102, so that the wheels 102 are rotationally driven. The traveling robot 100 moves with the wheels 102 rotationally driven.

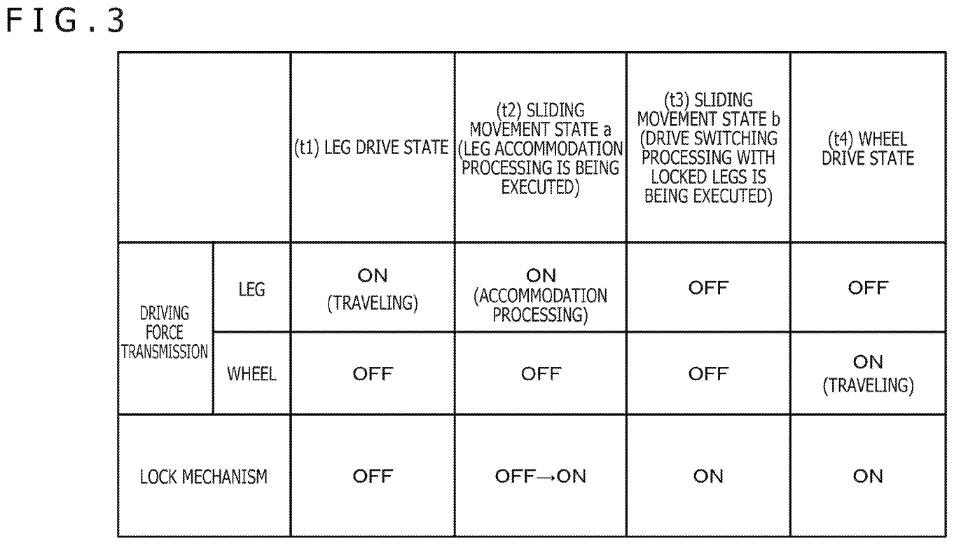

Settings of the following states (1) to (3) in the states (t1) to (t4) illustrated in FIG. 2 are described with reference to FIG. 3.

(1) Driving force transmission state (leg)

(2) Driving force transmission state (wheel)

(3) State of lock mechanism

FIG. 3 illustrates the settings of the following states (1) to (3):

(1) Driving force transmission state (leg);

(2) Driving force transmission state (wheel); and

(3) State of lock mechanism, in the following four states described with reference to FIG. 2:

(t1) Leg drive state;

(t2) Sliding movement state a (leg accommodation processing is being executed);

(t3) Sliding movement state b (drive switch processing with locked legs is being executed); and

(t4) Wheel drive state.

(t1) Leg Drive State

In the leg drive state, the following are set. (1) Driving force transmission state (leg)=ON (travel) (2) Driving force transmission state (wheel)=OFF (3) State of lock mechanism=OFF

That is, the driving force from the actuator such as a motor is transmitted to the legs 101 but is not transmitted to the wheels 102.

The legs 101 are driven by the driving force from the actuator such as a motor to move the traveling robot 100.

The lock mechanism is OFF, which means that the legs are not locked, that is, in an unlock state.

(t2) Sliding Movement State a (Leg Accommodation Processing Is Being Executed)

In the sliding movement state a (leg accommodation processing is being executed), the following are set.

(1) Driving force transmission state (leg)=ON (accommodation processing)

(2) Driving force transmission state (wheel=OFF

(3) State of lock mechanism=OFF→ON

That is, the driving force from the actuator such as a motor is transmitted to the legs 101 but is not transmitted to the wheels 102.

The legs 101 are driven by the driving force from the actuator such as a motor, so that the accommodation processing is performed. As described above, the driving force is not used for moving the traveling robot 100, and hence, the traveling robot 100 moves by sliding with the spinning wheels 102.

The lock mechanism changes from OFF to ON. The legs are locked or fixed when reaching the lock mechanism position.

(t3) Sliding Movement State b (Drive Switch Processing with Locked Legs Is Being Executed)

In the sliding movement state b (drive switch processing with locked legs is being executed), the following are set.

(1) Driving force transmission state (leg)=OFF

(2) Driving force transmission state (wheel)=OFF

(3) State of lock mechanism=ON

That is, the driving force from the actuator such as a motor is transmitted to neither the legs 101 nor the wheels 102.

This period is a period in which, by the clutches 103, the transmission destination of the driving force from the actuator such as a motor is switched from the legs 101 to the wheels 102.

The driving force from the actuator such as a motor is not used for moving the traveling robot 100, and hence, the traveling robot 100 moves by sliding with the spinning wheels 102.

The lock mechanism is ON, so that the legs are being fixed at the position of the lock mechanism 104.

(t4) Wheel Drive State

In the wheel drive state, the following are set.

(1) Driving force transmission state (leg)=OFF

(2) Driving force transmission state (wheel)=ON

(3) State of lock mechanism=ON

That is, the driving force from the actuator such as a motor is not transmitted to the legs 101 but is transmitted to the wheels 102.

In this period, the driving force from the actuator such as a motor is transmitted to the wheels 102, so that the traveling robot 100 moves with the rotating wheels 102.

The lock mechanism is ON, so that the legs are being fixed at the position of the lock mechanism 104.

As described with reference to FIG. 2 and FIG. 3, in the case of switching between the leg driving and the wheel driving, the processing of accommodating and locking the legs 104 and the processing of switching the transmission destination of the driving force from the actuator such as a motor by clutch control are required. In the periods of these processing processes, the driving force from the actuator such as a motor cannot be used for the movement (travel) of the traveling robot 100. That is, there is a driving force unavailable travel period in which the driving force cannot be applied to the movement processing.

As a result, the velocity of the traveling robot 100 decreases in the driving force unavailable travel period.

Note that switch processing from the leg driving to the wheel driving and switch processing from the wheel driving to the leg driving both have the driving force unavailable travel period.

The traveling robot 100 of the present disclosure executes control of suppressing a decrease in velocity in the driving force unavailable travel period.

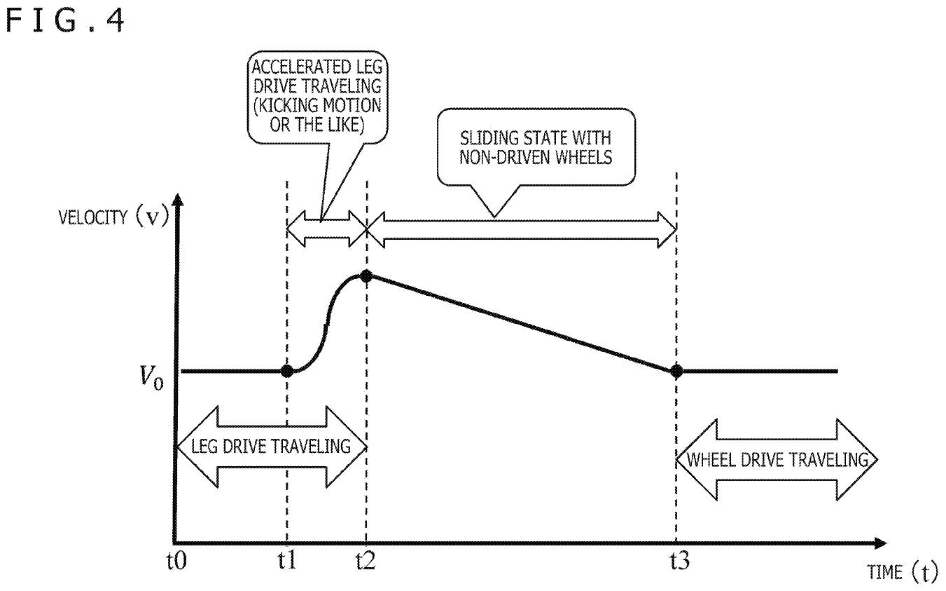

A specific control processing example is described with reference to FIG. 4.

A graph of FIG. 4 in which a horizontal axis indicates time (t) and a vertical axis indicates velocity (v) illustrates a change in velocity in switching from the leg drive traveling to the wheel drive traveling.

A period between Times t0 and t1 and a period between Times t1 and t2 correspond to a leg drive travel period.

A period between Times t2 and t3 is a period in which leg accommodation and driving force destination switching (switching from the legs to the wheels) by clutch operation are required. This period is the driving force unavailable travel period.

A period of Time t3 and thereafter is a wheel drive travel period.

The control unit of the traveling robot 100 of the present disclosure sets an accelerated leg drive travel period immediately before the leg drive traveling ends, that is, immediately before the traveling robot 100 transitions from the leg drive travel period to the driving force unavailable travel period.

This period is the period between Times t1 and t2 illustrated in the figure.

The control unit of the traveling robot 100 of the present disclosure controls, immediately before the traveling robot 100 enters the driving force unavailable travel period, the driving of the legs 101 to execute acceleration processing of increasing the travel velocity of the traveling robot 100. Specifically, for example, the control unit causes the legs 101 to execute kicking motion, to thereby accelerate the traveling robot 100.

After this acceleration processing, from Time t2, the traveling robot 100 transitions to the driving force unavailable travel period, that is, the period in which leg accommodation and driving force destination switch processing (switching from the legs to the wheels) by clutch operation are executed, so that the movement velocity gradually decreases.

At Time t3, the leg accommodation and the driving force destination switching (switching from the legs to the wheels) by clutch operation end, and the driving force from the actuator such as a motor is transmitted to the wheels 102, so that traveling by the wheel driving starts.

The travel velocity of the traveling robot 100 at Time t3, at which the wheel drive traveling starts, is substantially equal to a velocity V0 in the period between Times t0 and t1 in which the leg drive traveling has been executed. That is, the wheel drive traveling can start without a large decrease in velocity.

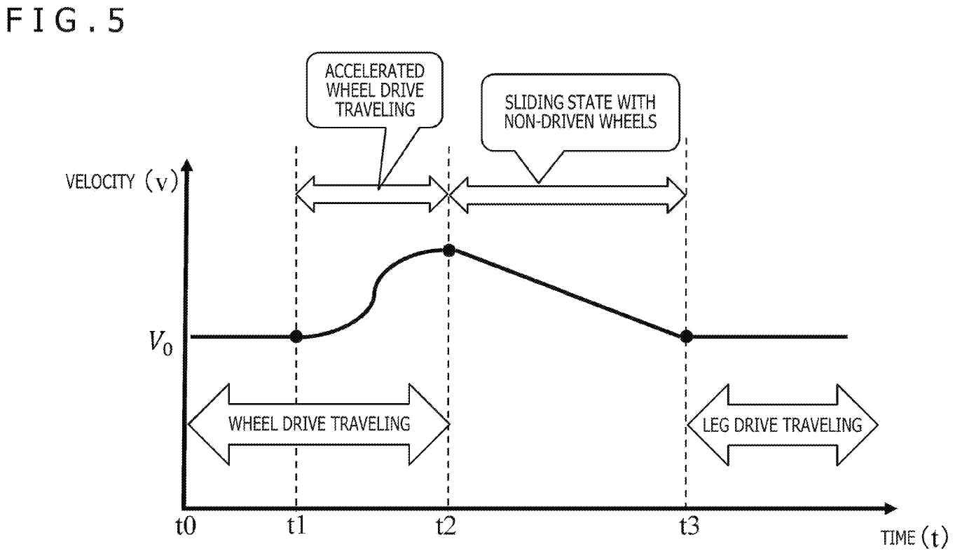

FIG. 5 illustrates a change in velocity in switching from the wheel drive traveling to the leg drive traveling.

A period between Times t0 and t1 and a period between Times t1 and t2 correspond to the wheel drive travel period.

A period between Times t2 and t3 is a period in which leg unlocking and driving force destination switching (switching from the wheels to the legs) by clutch operation are required. This period is the driving force unavailable travel period.

A period of Time t3 and thereafter is the leg drive travel period.

The control unit of the traveling robot 100 of the present disclosure sets an accelerated wheel drive travel period immediately before the wheel drive traveling ends, that is, immediately before the traveling robot 100 transitions from the wheel drive travel period to the driving force unavailable travel period.

This period is the period between t1 and t2 illustrated in the figure.

The control unit of the traveling robot 100 of the present disclosure controls, immediately before the traveling robot 100 enters the driving force unavailable travel period, the driving of the wheels 102 to execute acceleration processing of increasing the travel velocity of the traveling robot 100. Specifically, the control unit increases a rotation speed of the wheels 102 to accelerate the traveling robot 100.

After this acceleration processing, from Time t2, the traveling robot 100 transitions to the driving force unavailable travel period, that is, the period in which leg unlocking and driving force destination switch processing (switching from the wheels to the legs) by clutch operation are executed, so that the movement velocity gradually decreases.

At Time t3, the leg unlocking and the driving force destination switching (switching from the wheels to the legs) by clutch operation end, and the driving force from the actuator such as a motor is transmitted to the legs 101, so that traveling by the leg driving starts.

The travel velocity of the traveling robot 100 at Time t3, at which the leg drive traveling starts, is substantially equal to a velocity V0 in the period between Times t0 and t1 in which the wheel drive traveling has been executed. That is, the leg drive traveling can start without a large decrease in velocity.

### 2. Details of Switching Sequence from Leg Driving to Wheel Driving

Next, details of a switching sequence from the leg driving to the wheel driving that is executed by the traveling robot 100 of the present disclosure is described.

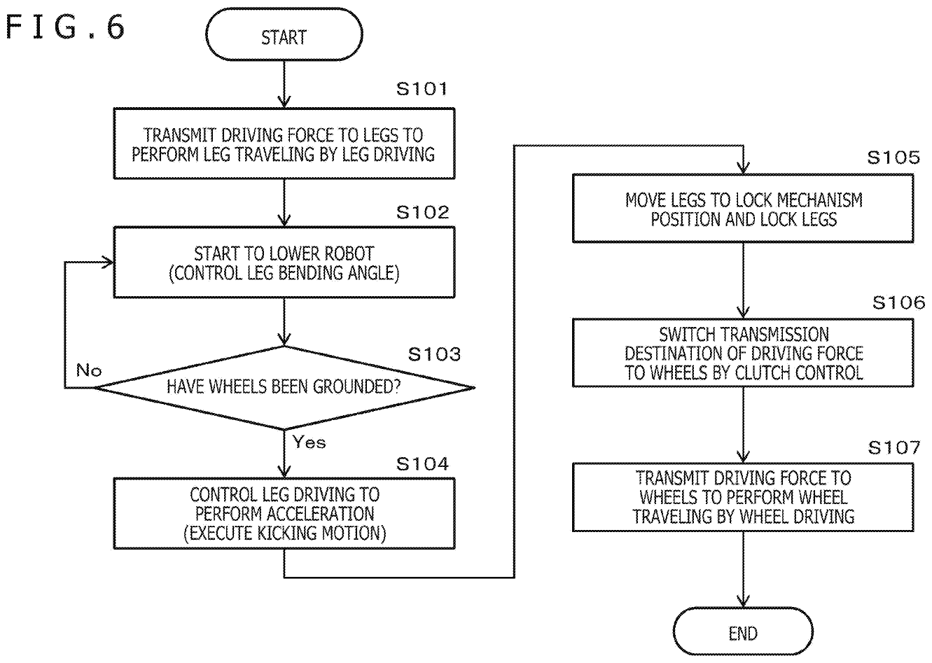

With reference to a flowchart of FIG. 6, the switching sequence from the leg driving to the wheel driving that is executed by the traveling robot 100 of the present disclosure is described.

Note that the control unit (data processing unit) of the traveling robot 100 can execute processing following the flowchart of FIG. 6 in accordance with a program stored in a storage unit of the traveling robot 100, for example. For example, the processing can be performed as program execution processing by a processor having a program execution function, such as a CPU.

Now, the processing in each step in the flow of FIG. 6 is described.

### Step S101

First, the control unit of the traveling robot 100 of the present disclosure transmits, in Step S101, a driving force from the actuator such as a motor to the legs 101, to thereby execute leg traveling by the leg driving.

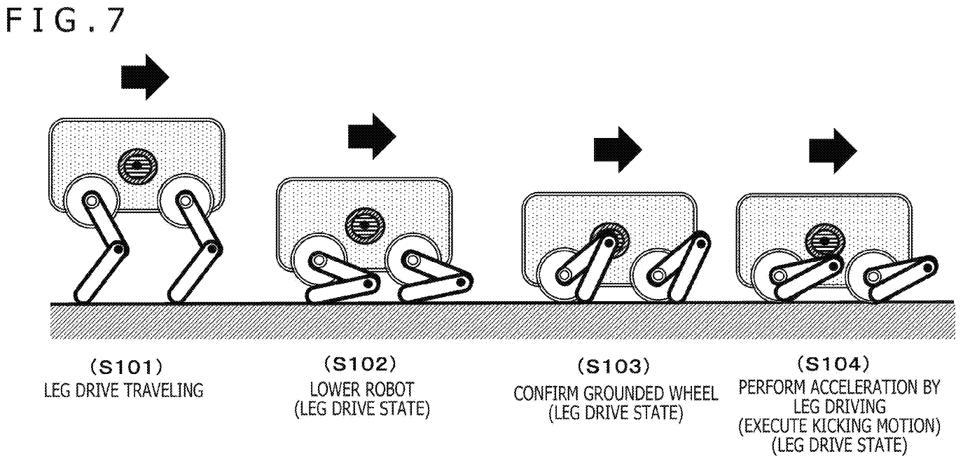

This state is a leg drive travel state illustrated in FIG. 7 (S101).

### Step S102

Next, the control unit starts, in Step S102, processing of lowering the traveling robot 100. This is preparation processing for a transition to traveling with the wheels 102. Specifically, the legs 101 are bent to lower the traveling robot 100.

This state is a robot lowering state illustrated in FIG. 7 (S102). Note that, also in this state, the driving force from the actuator such as a motor is transmitted to the legs 101, so that the leg traveling by the leg driving continues.

### Step S103

Next, the control unit determines, in Step S103, whether the wheels 102 of the traveling robot 100 have been grounded or not.

In a case where the wheels 102 have not been grounded, the processing returns to Step S102 and the lowering processing continues.

In a case where it is confirmed that the wheels 102 of the traveling robot 100 have been grounded, the processing proceeds to Step S104.

This state is a grounded wheel confirmation state illustrated in FIG. 7 (S103). Note that, also in this state, the driving force from the actuator such as a motor is transmitted to the legs 101, so that the leg traveling by the leg driving continues.

### Step S104

When it is confirmed in Step S103 that the wheels 102 of the traveling robot 100 have been grounded, the control unit executes acceleration processing by the leg driving in Step S104. For example, the control unit executes kicking motion to execute acceleration processing of increasing the travel velocity of the traveling robot.

This processing corresponds to the processing in the accelerated leg drive travel period between Times t1 and t2 described above with reference to FIG. 4.

This state is an accelerated leg drive state illustrated in FIG. 7 (S104). Note that, also in this state, the driving force from the actuator such as a motor is transmitted to the legs 101, so that the leg traveling by the leg driving continues.

### Step S105

After the acceleration processing including kicking motion or the like in Step S104, next, in Step S105, the control unit moves the legs 101 to the position of the lock mechanism 104 and locks or fixes the legs 101 to the lock mechanism 104.

Note that a driving force for moving the legs 101 here, that is, for moving the legs 101 to the position of the lock mechanism 104 is supplied from the actuator such as a motor. Thus, the driving force cannot be used for the processing of moving the traveling robot 100. That is, the traveling robot 100 is in a sliding state with the wheels 102 supplied with no driving force.

This processing corresponds to the first half of the processing in the sliding state with non-driven wheels in the period between Times t2 and t3 described above with reference to FIG. 4.

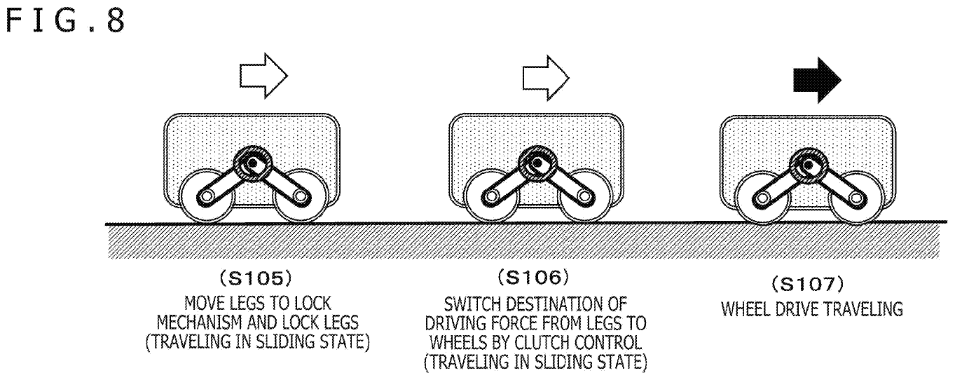

Further, this state is a state in which the processing of moving the legs 101 to the lock mechanism 104 and locking the legs 101 thereto, which is illustrated in FIG. 8 (S105), is being executed. As described above, the driving force from the actuator such as a motor is transmitted to the legs 101, but this driving force is used for the processing of moving the legs 101 to the lock mechanism. The traveling robot 100 is in the sliding state with the wheels 102 supplied with no driving force.

### Step S106

After the legs 101 have been locked to the lock mechanism 104 in Step S105, next, in Step S106, the control unit controls the clutches 103 to switch the transmission destination of the driving force from the actuator such as a motor from the legs 101 to the wheels 102.

This processing corresponds to the second half of the processing in the sliding state with non-driven wheels in the period between Times t2 and t3 described above with reference to FIG. 4.

Further, this state is a state in which the processing of switching the driving force destination from the legs 101 to the wheels 102 by clutch control, which is illustrated in FIG. 8 (S106), is being executed. In this period, the destination of the driving force from the actuator such as a motor is switched from the legs 101 to the wheels 102. However, in this switching period, the traveling robot 100 is in the sliding state with the wheels 102 supplied with no driving force.

### Step S107

After the switching of the transmission destination of the driving force in Step S106, that is, after the switch processing from the legs 101 to the wheels 102, the control unit transmits, in Step S107, the driving force from the actuator such as a motor to the wheels 102 to rotate the wheels 102. That is, the control unit causes the traveling robot 100 to travel by the wheel driving.

This processing corresponds to the processing in the wheel drive travel state in the period of Time t3 and thereafter described above with reference to FIG. 4.

Further, this state is a wheel drive travel state illustrated in FIG. 8 (S107). The driving force from the actuator such as a motor is transmitted to the wheels 102, so that the traveling robot 100 travels by the wheel driving.

In this way, the traveling robot 100 of the present disclosure executes the acceleration processing by the legs 101, for example, kicking motion to perform acceleration immediately before the processing of locking the legs 101 and driving force transmission destination switching (from the legs to the wheels) by clutch control. With this acceleration processing, an influence of a decrease in velocity that occurs in the processing of locking the legs 101 and driving force transmission destination switching by clutch control can be reduced, so that the velocity at the start of the wheel drive traveling can be kept at a velocity substantially equal to the velocity in the leg drive traveling. That is, the wheel drive traveling can start without a large decrease in velocity.

### 3. Details of Switching Sequence from Wheel Driving to Leg Driving

Next, details of a switching sequence from the wheel driving to the leg driving that is executed by the traveling robot 100 of the present disclosure is described.

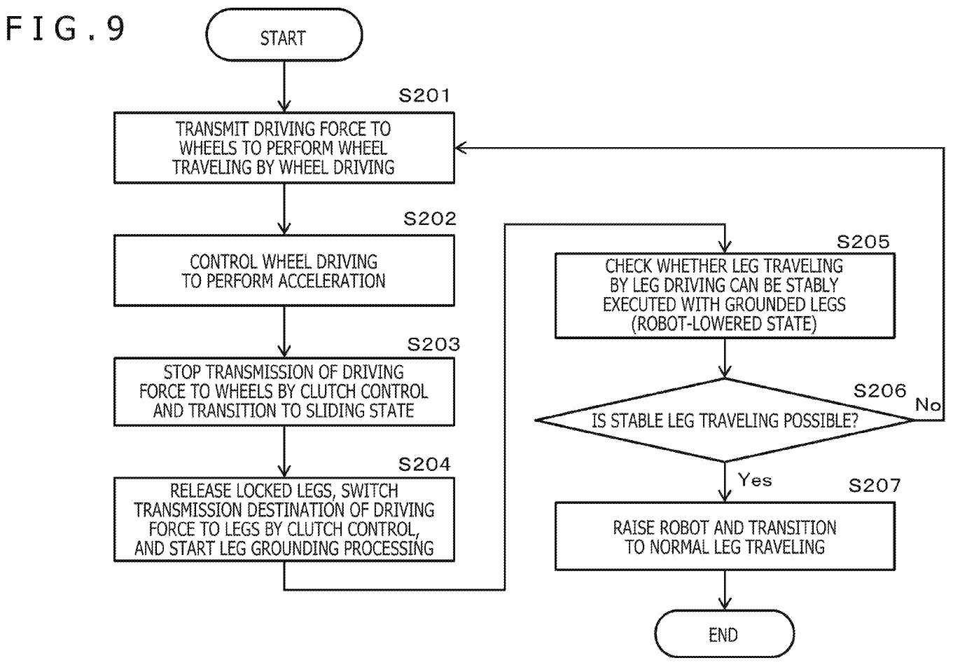

With reference to a flowchart of FIG. 9, the switching sequence from the wheel driving to the leg driving that is executed by the traveling robot 100 of the present disclosure is described.

Note that the control unit (data processing unit) of the traveling robot 100 can execute processing following the flowchart of FIG. 9 in accordance with a program stored in the storage unit of the traveling robot 100, for example. For example, the processing can be performed as program execution processing by a processor having a program execution function, such as a CPU.

Now, the processing in each step in the flow of FIG. 9 is described.

### Step S201

First, the control unit of the traveling robot 100 of the present disclosure transmits, in Step S201, a driving force from the actuator such as a motor to the wheels 102, to thereby execute traveling by the wheel driving.

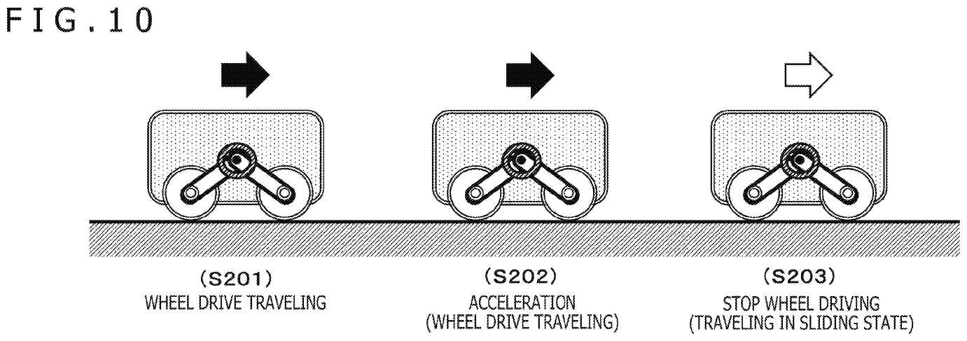

This state is a wheel drive travel state illustrated in FIG. 10 (S201).

### Step S202

Next, the control unit executes, in Step S202, acceleration processing by the wheel driving. For example, the control unit executes processing of increasing the rotation speed of the wheels 102, thereby executing the traveling robot acceleration processing.

This processing corresponds to the processing in the accelerated wheel drive travel period between Times t1 and t2 described above with reference to FIG. 5.

This state is an accelerated wheel drive state illustrated in FIG. 10 (S202). Note that, also in this state, the driving force from the actuator such as a motor is transmitted to the wheels 102, so that the traveling by the wheel driving continues.

### Step S203

After the acceleration processing in Step S202, next, in Step S203, the control unit controls the clutches 103 to switch the transmission destination of the driving force from the actuator such as a motor from the wheels 102 to the legs 101.

This processing corresponds to the first half of the processing in the sliding state with non-driven wheels in the period between Times t2 and t3 described above with reference to FIG. 5.

Further, this state is a wheel drive stop state illustrated in FIG. 10 (S203). In this period, the destination of the driving force from the actuator such as a motor is switched from the wheels 102 to the legs 101. In this switching period, the traveling robot 100 is in the sliding state with the wheels 102 supplied with no driving force.

### Step S204

After the clutch control in Step S203, that is, after the switching of the transmission destination of the driving force from the actuator such as a motor from the wheels 102 to the legs 101, next, in Step S204, the control unit releases the legs 101 from the lock mechanism 104, and starts the processing of grounding the legs 101 with the driving force from the actuator such as a motor.

This processing corresponds to the second half of the processing in the sliding state with non-driven wheels in the period between Times t2 and t3 described above with reference to FIG. 5.

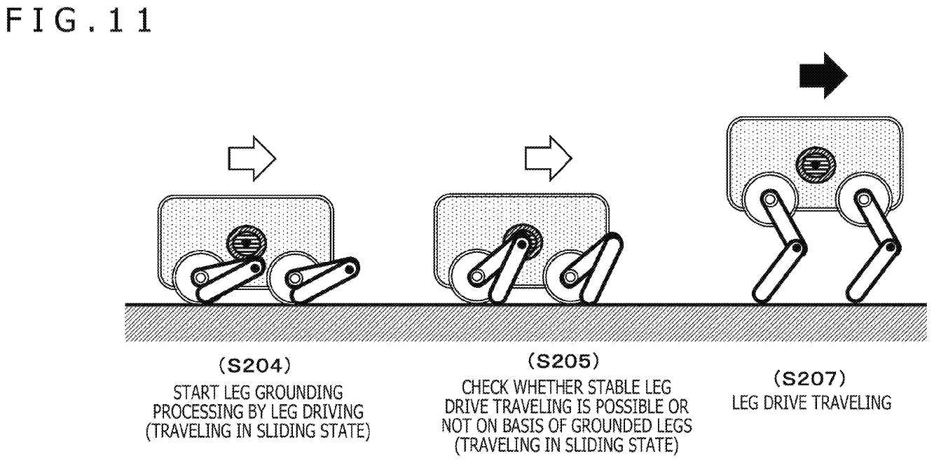

Further, this state is a leg drive grounding processing start state illustrated in FIG. 11 (S204). In this period, the driving force from the actuator such as a motor is transmitted to the legs 101, but this driving force is used for the movement processing of the legs 101 necessary for grounding the legs 101. Thus, the traveling robot 100 is in the sliding state with the wheels 102 supplied with no driving force.

### Steps S205 and S206

Next, in Steps S205 and S206, the control unit confirms that the legs 101 have been grounded and determines whether stable traveling is possible or not by driving with the legs 101. Specifically, for example, each of the four legs is experimentally brought into contact with and separated from the travel surface, to thereby determine whether stable leg drive traveling is possible or not.

Note that this processing is executed in the sliding state with non-driven wheels with the grounded wheels 102.

In a case where it is determined that stable leg drive traveling is impossible, the processing returns to Step S201, and the traveling robot 100 is switched to the wheel driving.

Meanwhile, in a case where it is determined that stable leg drive traveling is possible, the processing proceeds to Step S207.

The processing in Steps S205 and S206 also corresponds to the second half of the processing in the sliding state with non-driven wheels in the period between Times t2 and t3 described above with reference to FIG. 5. That is, the traveling robot 100 is in the sliding state with the wheels 102 supplied with no driving force.

### Step S207

In the case where it is determined in Steps S205 and S206 that stable leg drive traveling is possible, in Step S207, the control unit raises the robot and starts the normal leg drive traveling.

This processing corresponds to the processing in the leg drive travel state in the period of Time t3 and thereafter described above with reference to FIG. 5.

Further, this state is a leg drive travel state illustrated in FIG. 11 (S207). The driving force from the actuator such as a motor is transmitted to the wheels 102, so that the traveling robot 100 travels by the wheel driving.

In this way, the traveling robot 100 of the present disclosure performs the acceleration processing by the wheels 102, for example, increases the rotation speed of the wheels 102 to perform acceleration before performing the driving force transmission destination switch processing (from the wheels to the legs) by clutch control and the processing of unlocking and grounding the legs 101. With this acceleration processing, an influence of a decrease in velocity that occurs in the processing periods of the driving force transmission destination switch processing by clutch control and the leg grounding processing can be reduced, so that the velocity at the start of the leg drive traveling can be kept at a velocity substantially equal to the velocity in the wheel drive traveling. That is, the leg drive traveling can start without a large decrease in velocity.

### 4. Other Embodiments

Next, other embodiments to which the processing of the present disclosure is applicable are described.

In the embodiment described above, the four-leg/four-drive wheel traveling robot 100 including the four legs 101 and the four wheels 102 has been described as an example.

The processing of the present disclosure is applicable not only to four-leg/four-drive wheel traveling robots but also to various traveling robots including any number of legs or wheels.

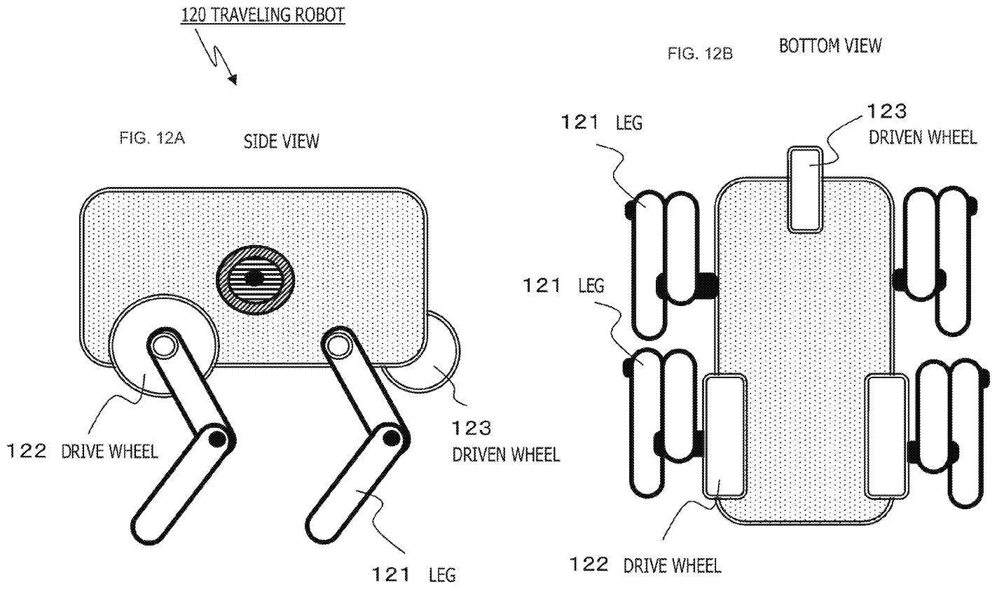

For example, a traveling robot 120 illustrated in FIG. 12 has a three-wheel configuration including two drive wheels 122 configured to be driven by an actuator such as a motor and a driven wheel 123 that is supplied with no driving force from the actuator.

The traveling robot 120 includes four legs 121 all of which are supplied with a driving force from the actuator.

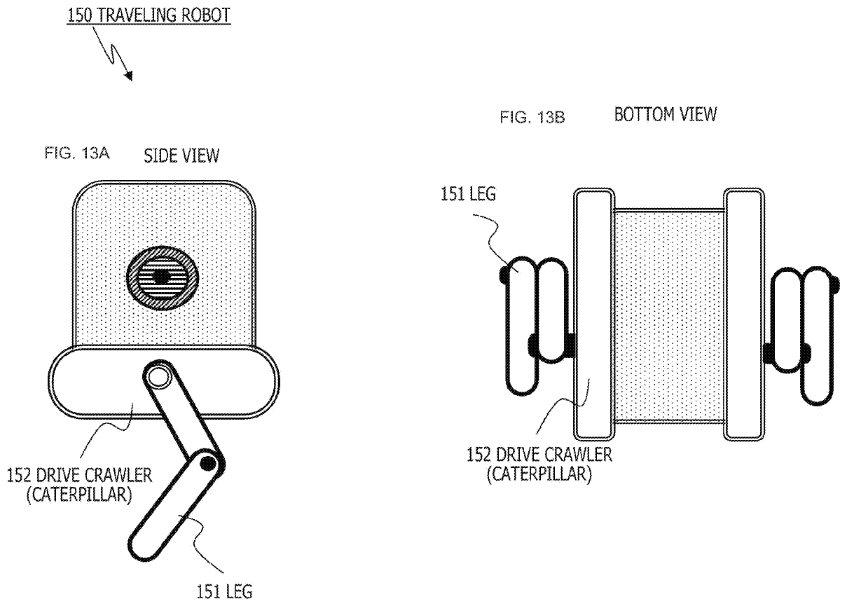

Further, a traveling robot 150 illustrated in FIG. 13 has a configuration including two drive crawlers (caterpillars) 152 configured to be driven by an actuator such as a motor. The traveling robot 150 includes two legs 151 configured to be driven by a driving force from the actuator.

In this way, the processing of the present disclosure is applicable not only to four-leg/four-drive wheel traveling robots but also to various traveling robots including any number of legs or wheels.

Further, in the embodiment described above, the surface on which the traveling robot 100 travels is a plane surface, but the travel surface of the traveling robot 100 is not limited to a plane surface.

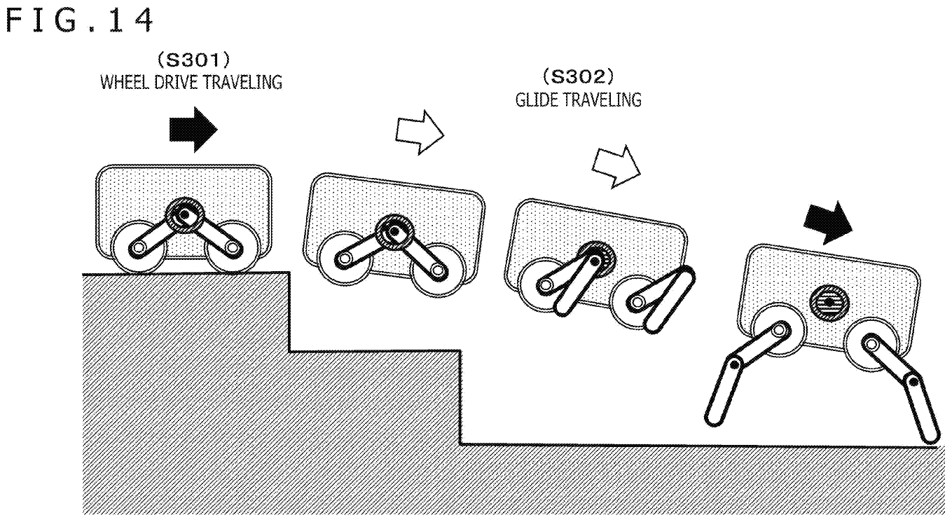

With reference to FIG. 14 and the following figures, operation examples of the traveling robot 100 in a case where the travel surface is not a plane surface are described.

FIG. 14 is an example of a case in which the travel surface has steps and the traveling robot 100 descends the stepped travel surface.

In Step S301, the traveling robot 100 travels by the wheel driving on an uppermost step of the stairs. The traveling robot 100 is switched from the wheel drive traveling to the leg drive traveling while descending the stairs.

In this case, the traveling robot 100 transitions to a gliding state without traveling in contact with the surface of the stairs that is the travel surface as illustrated in Step S302 of the figure and then lands on a lowermost step of the stairs by using the legs 101 to start traveling by the leg driving.

In acceleration processing in the drive switching in this case, a weaker acceleration control is performed by considering an influence of acceleration due to a fall.

The traveling robot 100 calculates, on the basis of information detected by the sensors, a fall distance and a gliding time to calculate a necessary acceleration processing level, to thereby execute the acceleration processing.

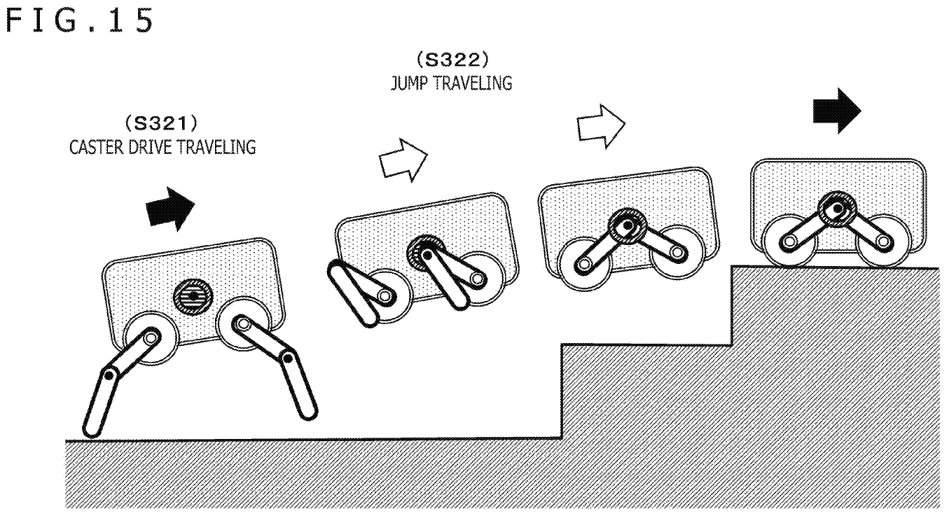

FIG. 15 is an example of a case in which the travel surface has steps as in FIG. 14 but the traveling robot 100 ascends the stepped travel surface.

In Step S321, the traveling robot 100 travels by the leg driving on the lowermost step of the stairs. The traveling robot 100 is switched from the leg drive traveling to the wheel drive traveling while ascending the stairs.

In this case, the traveling robot 100 jumps over the surface of the stairs that is the travel surface without traveling in contact with the surface as illustrated in Step S322 of the figure and then lands on the uppermost step of the stairs by using the wheels 102 to start traveling by the wheel driving.

In acceleration processing in the drive switching in this case, a stronger acceleration control is performed by considering an influence of a decrease in velocity due to the jump processing.

The traveling robot 100 calculates, on the basis of information detected by the sensors, how high the traveling robot 100 is to jump and a gliding time to calculate a necessary acceleration processing level, to thereby execute the acceleration processing.

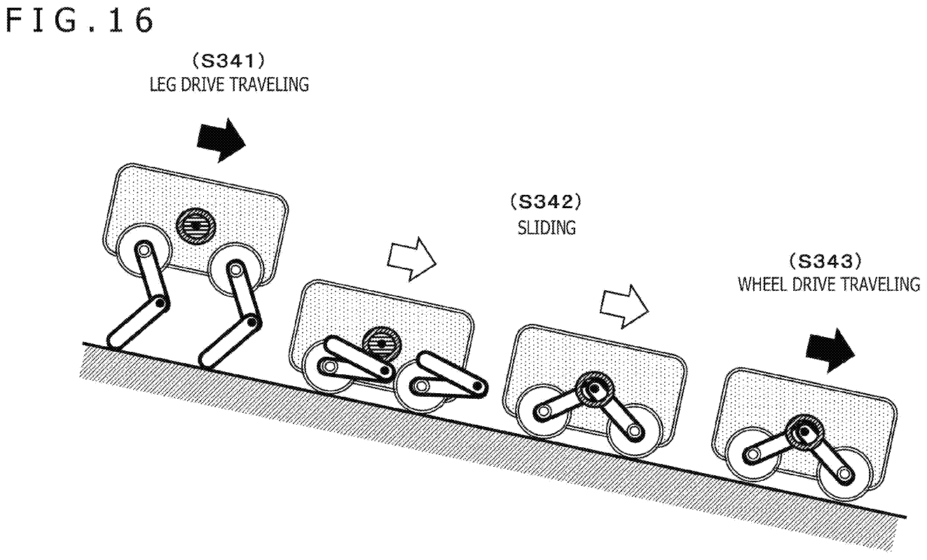

FIG. 16 is an example of a case in which the travel surface is a slope and the traveling robot 100 descends the slope.

In Step S341, the traveling robot 100 travels by the leg driving to descend the slope. The traveling robot 100 is switched from the leg drive traveling to the wheel drive traveling while descending the slope.

In this case, while descending the slope that is the travel surface, the traveling robot 100 transitions to a sliding state with non-driven wheels as in Step S342 and then transitions to a wheel drive traveling in Step S343.

In acceleration processing in the drive switching in this case, a weaker acceleration control is performed by considering an influence of acceleration due to the descending of the slope.

The traveling robot 100 calculates, on the basis of information detected by the sensors, a fall distance and a sliding time on the slope to calculate a necessary acceleration processing level, to thereby execute the acceleration processing.

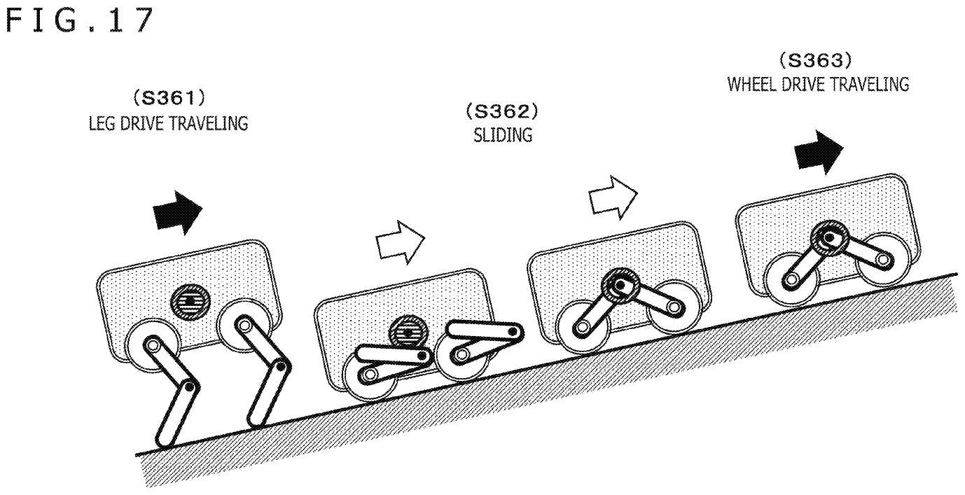

FIG. 17 is an example of a case in which the travel surface is a slope as in FIG. 16 but the traveling robot 100 ascends the slope.

In Step S361, the traveling robot 100 travels by the leg driving to ascend the slope. The traveling robot 100 is switched from the leg drive traveling to the wheel drive traveling while ascending the slope.

In this case, while ascending the slope that is the travel surface, the traveling robot 100 transitions to a sliding state with non-driven wheels as in Step S362 and then transitions to a wheel drive traveling in Step S363.

In acceleration processing in the drive switching in this case, a stronger acceleration control is performed by considering an influence of a decrease in velocity due to the ascending of the slope.

The traveling robot 100 calculates, on the basis of information detected by the sensors, a degree of the slope and a sliding time with non-driven wheels to calculate a necessary acceleration processing level, to thereby execute the acceleration processing.

In this way, the traveling robot of the present disclosure performs control depending on various travel surfaces.

That is, the traveling robot executes, in switching from the leg drive traveling to the wheel drive traveling, acceleration processing such as kicking motion at the end of the leg drive traveling such that a velocity at the start of the wheel drive traveling is substantially the same as a velocity in the leg drive traveling.

Further, the traveling robot controls, in switching from the wheel drive traveling to the leg drive traveling, the rotation speed of the wheels to execute acceleration processing at the end of the wheel drive traveling such that a velocity at the start of the leg drive traveling is substantially the same as a velocity in the wheel drive traveling.

With these processing processes, an influence of a decrease in travel velocity that occurs in the periods of switching by the clutches, the leg locking or unlocking processing, the grounding processing, and the like can be reduced, so that a stable travel velocity can be maintained.

### 5. Hardware Configuration Example of Traveling Robot

Next, a hardware configuration example of the traveling robot 100 is described.

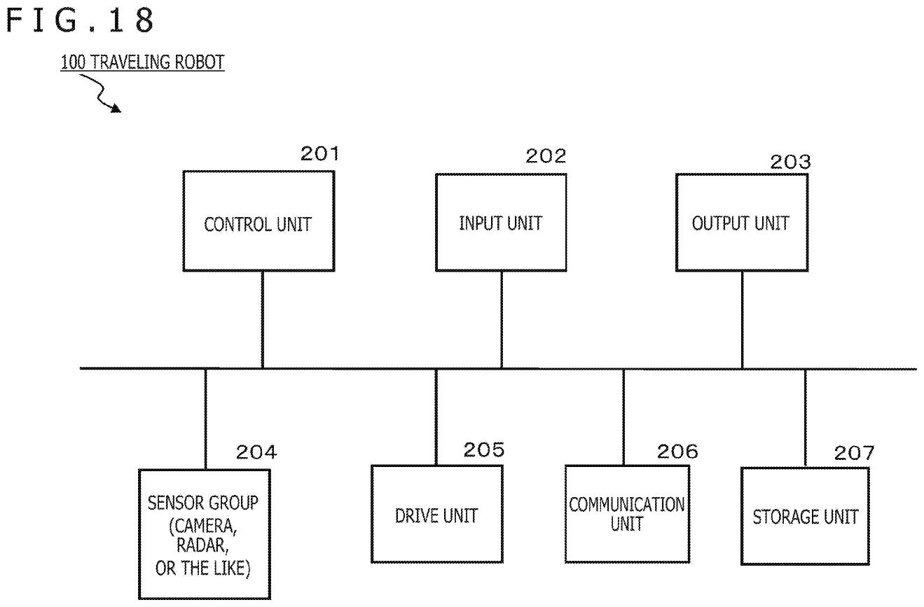

FIG. 18 is a block diagram illustrating a configuration example of the traveling robot 100 of the present disclosure.

As illustrated in FIG. 18, the traveling robot 100 includes a control unit 201, an input unit 202, an output unit 203, a sensor group 204, a drive unit 205, a communication unit 206, and a storage unit 207.

The control unit 201 controls processing that is executed in the traveling robot 100. For example, the control unit 201 executes processing in accordance with a control program stored in the storage unit 207. The control unit 201 includes a processor having a program execution function.

The input unit 202 is an interface capable of receiving various kinds of data input by a user and includes a touch panel, a code reading unit, various switches, and the like.

The output unit 203 is a speaker configured to output alerts or sound, a display configured to output images, or an output unit configured to output light or the like.

The sensor group 204 includes various sensors such as a camera, a microphone, a radar, and a distance sensor.

The drive unit 205 includes the actuator such as a motor that is the drive unit for the wheels and the legs for moving the traveling robot 100, a direction control mechanism, and the like.

The communication unit 206 executes communication processing with a management server and external equipment such as external sensors, for example.

The storage unit 207 stores travel route information, information regarding programs that are executed in the control unit 201, and the like.

### 6. Conclusion of Configuration of Present Disclosure

In the above, the embodiment of the present disclosure has been described in detail by referring to the specific embodiments. However, it is obvious that those skilled in the art can make modifications or substitutions of the embodiments without departing from the gist of the present disclosure. That is, the present invention has been disclosed in a form of an example, and should not be limitedly interpreted. In order to determine the gist of the present disclosure, the appended claims should be taken into account.

Note that the technology disclosed herein can take the following configurations.

(1) A traveling robot including:

a drive unit;

a clutch configured to switch a transmission destination of a driving force from the drive unit;

a leg configured to be driven by the driving force from the drive unit;

a wheel configured to be driven by the driving force from the drive unit; and

a control unit,

in which the control unit executes, in drive switching between leg driving and wheel driving, travel velocity control before the drive switching such that a travel velocity after the drive switching is substantially equal to a travel velocity before the drive switching.

(2) The traveling robot according to Item (1), in which the control unit sets, in the drive switching between the leg driving and the wheel driving, a sliding movement state in which the wheel is caused to slide in a non-driven state.

(3) The traveling robot according to Item (1) or (2), in which the control unit executes, in drive switching from the leg driving to the wheel driving, acceleration processing by changing a leg drive mode when executing the leg driving before the drive switching such that a travel velocity in the wheel driving after the drive switching is substantially equal to a travel velocity in the leg driving before the drive switching.

(4) The traveling robot according to Item (3), in which the control unit causes kicking motion to be executed by the leg, as the acceleration processing.

(5) The traveling robot according to any one of Items (1) to (4), in which the control unit executes, in drive switching from the wheel driving to the leg driving, acceleration processing by changing a wheel drive mode when executing the wheel driving before the drive switching such that a travel velocity in the leg driving after the drive switching is substantially equal to a travel velocity in the wheel driving before the drive switching.

(6) The traveling robot according to Item (5), in which the control unit executes, as the acceleration processing, control of increasing a rotation speed of the wheel.

(7) The traveling robot according to any one of Items (1) to (6), further including:

a lock mechanism for the leg,

in which the control unit executes, in the wheel driving, processing of keeping the leg fixed to the lock mechanism.

(8) The traveling robot according to any one of Items (1) to (7), in which the control unit performs, in drive switching from the leg driving to the wheel driving, control of using the driving force from the drive unit for leg movement processing for fixing the leg to a lock mechanism.

(9) The traveling robot according to any one of Items (1) to (8), in which the control unit executes, in drive switching from the leg driving to the wheel driving, acceleration control when executing the leg driving before the drive switching, by considering a decrease in velocity in a period in which leg movement processing of fixing the leg to a lock mechanism and processing of switching the transmission destination of the driving force from the drive unit from the leg to the wheel by the clutch are executed.

(10) The traveling robot according to any one of Items (1) to (9), in which the control unit executes, in drive switching from the wheel driving to the leg driving, acceleration control when executing the wheel driving before the drive switching, by considering a decrease in velocity in a period in which processing of switching the transmission destination of the driving force from the drive unit from the wheel to the leg by the clutch and leg movement processing of releasing the leg locked and grounding the leg are executed.

(11) A traveling robot control method executed by a traveling robot,

the traveling robot including
a drive unit,
a clutch configured to switch a transmission destination of a driving force from the drive unit,
a leg and a wheel that are configured to be driven by the driving force from the drive unit, and
a control unit,

in which the control unit executes, in drive switching between leg driving and wheel driving, travel velocity control before the drive switching such that a travel velocity after the drive switching is substantially equal to a travel velocity before the drive switching.

(12) A program for causing a traveling robot to execute traveling robot control,

the traveling robot including
a drive unit,
a clutch configured to switch a transmission destination of a driving force from the drive unit,
a leg and a wheel that are configured to be driven by the driving force from the drive unit, and
a control unit,

in which the program causes the control unit to execute, in drive switching between leg driving and wheel driving, travel velocity control before the drive switching such that a travel velocity after the drive switching is substantially equal to a travel velocity before the drive switching.

Note that the series of processing processes described herein can be executed by hardware, software, or a combination thereof. In the case where the series of processing processes is executed by software, a program having recorded thereon the processing sequence can be installed on a memory in a computer embedded in dedicated hardware and executed. Alternatively, the program can be installed on a general-purpose computer capable of executing various types of processing and executed. For example, the program can be recorded on a recording medium in advance. Instead of being installed from a recording medium to a computer, the program can be received via a network, such as a LAN (Local Area Network) or the Internet, to be installed on a recording medium such as a built-in hard disk.

Further, the various types of processing described herein may be executed time-serially as described above, or may also be executed in parallel or individually on the basis of the processing capability of a device configured to execute the processing, or as needed. Further, the term “system” herein includes a configuration in which a plurality of devices is logically grouped and is not limited to a configuration in which the devices are disposed within the same housing.

### INDUSTRIAL APPLICABILITY

As described above, according to a configuration of an embodiment of the present disclosure, the traveling robot configured to travel by switching between the leg driving and the wheel driving while suppressing a decrease in velocity in switching between the leg driving and the wheel driving is achieved.

Specifically, for example, the traveling robot includes a drive unit, a clutch configured to switch a transmission destination of a driving force from the drive unit, a leg and a wheel that are configured to be driven by the driving force from the drive unit, and a control unit. The control unit executes, in drive switching between leg driving and wheel driving, travel velocity control before the drive switching such that a travel velocity after the drive switching is substantially equal to a travel velocity before the drive switching. The control unit sets, in the drive switching between the leg driving and the wheel driving, a sliding movement state in which the wheel is caused to slide in a non-driven state. The control unit executes, in the drive switching, acceleration processing before the drive switching such that a travel velocity after the drive switching is substantially equal to a travel velocity before the drive switching.

With this configuration, the traveling robot configured to travel by switching between the leg driving and the wheel driving while suppressing a decrease in velocity in switching between the leg driving and the wheel driving is achieved.

### REFERENCE SIGNS LIST

100: Traveling robot
101: Leg
102: Wheel
103: Clutch
104: Lock mechanism
120: Traveling robot
121: Leg
122: Drive wheel
123: Driven wheel
150: Traveling robot
151: Leg
152: Drive crawler (caterpillar)
201: Control unit
202: Input unit
203: Output unit
204: Sensor group
205: Drive unit
206: Communication unit
207: Storage unit

1. A traveling robot comprising:
a drive unit;
a clutch configured to switch a transmission destination of a driving force from the drive unit;
a leg configured to be driven by the driving force from the drive unit;
a wheel configured to be driven by the driving force from the drive unit; and
a control unit,
wherein the control unit executes, in drive switching between leg driving and wheel driving, travel velocity control before the drive switching such that a travel velocity after the drive switching is substantially equal to a travel velocity before the drive switching.

2. The traveling robot according to claim 1, wherein the control unit sets, in the drive switching between the leg driving and the wheel driving, a sliding movement state in which the wheel is caused to slide in a non-driven state.

3. The traveling robot according to claim 1, wherein the control unit executes, in drive switching from the leg driving to the wheel driving, acceleration processing by changing a leg drive mode when executing the leg driving before the drive switching such that a travel velocity in the wheel driving after the drive switching is substantially equal to a travel velocity in the leg driving before the drive switching.

4. The traveling robot according to claim 3, wherein the control unit causes kicking motion to be executed by the leg, as the acceleration processing.

5. The traveling robot according to claim 1, wherein the control unit executes, in drive switching from the wheel driving to the leg driving, acceleration processing by changing a wheel drive mode when executing the wheel driving before the drive switching such that a travel velocity in the leg driving after the drive switching is substantially equal to a travel velocity in the wheel driving before the drive switching.

6. The traveling robot according to claim 5, wherein the control unit executes, as the acceleration processing, control of increasing a rotation speed of the wheel.

7. The traveling robot according to claim 1, further comprising:
a lock mechanism for the leg,
wherein the control unit executes, in the wheel driving, processing of keeping the leg fixed to the lock mechanism.

8. The traveling robot according to claim 1, wherein the control unit performs, in drive switching from the leg driving to the wheel driving, control of using the driving force from the drive unit for leg movement processing for fixing the leg to a lock mechanism.

9. The traveling robot according to claim 1, wherein the control unit executes, in drive switching from the leg driving to the wheel driving, acceleration control when executing the leg driving before the drive switching, by considering a decrease in velocity in a period in which leg movement processing of fixing the leg to a lock mechanism and processing of switching the transmission destination of the driving force from the drive unit from the leg to the wheel by the clutch are executed.

10. The traveling robot according to claim 1, wherein the control unit executes, in drive switching from the wheel driving to the leg driving, acceleration control when executing the wheel driving before the drive switching, by considering a decrease in velocity in a period in which processing of switching the transmission destination of the driving force from the drive unit from the wheel to the leg by the clutch and leg movement processing of releasing the leg locked and grounding the leg are executed.

11. A traveling robot control method executed by a traveling robot,
the traveling robot including
a drive unit,
a clutch configured to switch a transmission destination of a driving force from the drive unit,
a leg and a wheel that are configured to be driven by the driving force from the drive unit, and
a control unit,
wherein the control unit executes, in drive switching between leg driving and wheel driving, travel velocity control before the drive switching such that a travel velocity after the drive switching is substantially equal to a travel velocity before the drive switching.

12. A program for causing a traveling robot to execute traveling robot control,
the traveling robot including
a drive unit,
a clutch configured to switch a transmission destination of a driving force from the drive unit,
a leg and a wheel that are configured to be driven by the driving force from the drive unit, and
a control unit,
wherein the program causes the control unit to execute, in drive switching between leg driving and wheel driving, travel velocity control before the drive switching such that a travel velocity after the drive switching is substantially equal to a travel velocity before the drive switching.
